(19) United States
(12) Patent Application Publication
(10) Pub. No.: US 2004/0069235 A1
(43) Pub. Date: Apr. 15, 2004

(54) Flea feeding apparatus

(76) Inventors: Cordelia G. Rasa, Edison, NJ (US); Harold W. Heimbach, Howell, NJ (US); Wesley L. Shoop, Hillsborough, NJ (US); Michelle Zakson-Aiken, New Brunswick, NJ (US)

Correspondence Address: MERCK AND CO INC, P O BOX 2000, RAHWAY, NJ, 070650907

(21) Appl. No.: 10/673,728

(22) Filed: Sep. 29, 2003

Related U.S. Application Data
(60) Provisional application No. 60/414,146, filed on Sep. 27, 2002.

(51) Int. Cl. A01K 1/10

(52) U.S. Cl. 119/51.01

(57) ABSTRACT

The present invention is directed to a flea feeding apparatus and method for obtaining in vivo feeding data for fleas feeding from a blood source. In particular, the present invention is directed to a flea feeding apparatus and method for obtaining in vivo flea feeding data for fleas feeding from blood sources such as, for example, a mammal or reptile. The flea feeding apparatus includes a containment system comprised of a subject-restraining apparatus and a removable housing that confine the fleas in proximity with the blood source in order to obtain in vivo flea feeding data. This invention allows a known quantity of fleas to feed on a test blood source undisturbed, followed by the recovery of all of the fleas for further observation and analysis, with minimal stress and manipulation of the blood source (test animal host).

### FIELD OF THE INVENTION

The present invention is directed to a flea feeding apparatus and method for obtaining in vivo feeding data for fleas feeding from a blood source. In particular, the present invention is directed to a flea feeding apparatus and method for obtaining in vivo flea feeding data for fleas feeding from blood sources such as, for example, a mammal or reptile.

### BACKGROUND OF THE INVENTION

Flea infestation of animals is of health and economic concern because they are known to cause and/or transmit a variety of diseases. Fleas cause or carry diseases such as flea allergy dermatitis, anemia, murine typhus, plague, and tapeworm. The medical and veterinary importance of flea infestation has prompted the study of the biology of fleas. Such studies often require feeding fleas directly on animals to observe disease transmission, host association, identification and efficacy of systemic inhibitory agents. However, it has been difficult to obtain statistically significant data, particularly statistical significance in small changes, in direct feeding studies of free-roaming fleas on a host animal because, problematically, fleas and their eggs are often lost during or after such experiments. Studies in which fleas have been confined in cages together with the blood host have the problem of accounting for adult fleas and eggs, leading to statistical errors and difficulties in evaluating results.

In an attempt to better account for all fleas and flea eggs during a feeding study, other investigators have attempted to confine fleas in chambers attached to animals by various means. Such chambers would be impractical for use in small animals because of their relative size, preparation time, and fur grooming habits. Typically, the host animal will groom itself to rid the irritation at the site of feeding. In order to study the biology of fleas, the fleas should be allowed to feed without disturbance, or disruption.

Thus, there is a need for a product and method that allows fleas to be confined for direct feeding experiments on animal hosts which avoids loss of fleas and eggs. Most experiments use dogs and cats as the animal hosts. However, because of public reaction and experimental costs with the use of such animals, there is a need for a bioassay that uses smaller animal hosts such as the mouse or rat.

Previous efforts determined that fleas could feed on mice successfully as long as they were protected from mouse grooming. This finding lead to a model to identify and characterize in vivo flea efficacy and duration of activity of chemically diverse flea active compounds prior to testing in larger animals. In this model, fleas were only placed on sedated mice for a set flea exposure and feeding period. At the end of the feeding period, live fleas were then removed from the mice by combing the mice, by picking up fleas that jumped off the mice onto counters or handlers, or by manually pulling the fleas off the coat of the mice. Disadvantages with this method included the time expenditure for flea recovery and the loss of escaping fleas. Furthermore, the sedated mice undergo losses in body temperature that negatively affect flea-feeding behavior.

Rodent restrainers are available from, for example, Harvard Apparatus, Inc. (Holliston, Ma.) which include Heated/Unheated Rodent Restrainers constructed of clear acrylic and may be found in pages C2-C8 of the 1997-1998 Harvard Apparatus Catalog. These transparent rodent restrainers are cylindrical tubes secured onto a sturdy, flat base. The rodent restrainers are also designed with a series of small holes on each side to facilitate injections of the animal. Nevertheless, the Harvard rodent restrainers do not provide a means for securing a removable flea/insect-feeding insert against the restrained animal. None provides an animal-restraining device that affords the practical means to secure a flea cage for flea exposure studies. Thus, there exists a need for an improved animal-restraining device having the capability of securing a removable flea cage for in vivo flea feeding studies.

U.S. Pat. No. 5,927,234 describes an animal restraining method that positions the animal and facilitates injecting and handling the animal. U.S. Pat. No. 5,133,289 and U.S. Pat. No. Reissue 35,348 describe systems and methods for breeding fleas and hematophagous insects. U.S. Pat. No. 5,849,262 describes a bioassay system for arthropods that elastically attaches to an animal.

S. Colombine et al., Veterinary Dermatology, 12:155-161(2001) describes a technique in which fleas are placed in Plexiglas feeding cages secured with a binding to a shaved skin region of a cat.

A. Farhang-Azad et al., Am J Trop Med Hyg. 34(3):555-563(1985), A. Farhang-Azad et al., J. Med. Entomol., 21(6):675-680(1984), and A. Farhang-Azad et al., Am J Trop Med Hyg. 32(6):1392-1400(1983), describe a technique wherein suckling immature rats were placed individually in glass jars containing fleas for their experiments. The immature rats were incapable of animal grooming that disturbs flea feeding and possibly flea death, but the problem regarding flea recovery was not eliminated by such protocol.

Lee, S. E. et al., Parasite Immunology 19(1):13-19(1997) describes shaving the abdomens of anaesthetized mice and clamping a test tube containing fleas to the mice by wrapping gauze tightly to the skin. However, the body temperature of mice decreases when under sedation, thus possibly negatively affecting the feeding rate of fleas.

Santora K. A. et al., Veterinary Parasitology, 104(3):257-264(2002) describes the development of a mouse model to evaluate the potential of flea-control compounds. A test mouse was restrained in a clear polypropylene container and exposed to defined number of fleas by direct placement between its shoulder blades. The fleas were not placed in a separate container attachment, therefore flea recovery was by conventional means of combing the mouse and aspirating the fleas into individual test tubes. Alternatively, a mouse was shaved prior to flea exposure to facilitate recovery and eliminate combing the mouse. However, this method did not minimize the risk of escape of fleas during recovery or eliminate human error. Another experimental attempt involved placing the mouse tail in a glass vial, which contained fleas, but the feeding success was poor at a level of only 20%.

Thus, there is a need for a flea feeding apparatus and method for obtaining in vivo feeding data for fleas feeding from a blood source in which 1) the blood source is not sedated, 2) the blood source can be mature, 3) the fleas are contained yet active, 4) the fleas are easily accounted for, and 5) the exposure time is easily controlled and measured.

### SUMMARY OF THE INVENTION

The present invention is directed to a flea feeding apparatus and method for obtaining in vivo feeding data for fleas feeding from a blood source. In particular, the present invention is directed to a flea feeding apparatus and method for obtaining in vivo flea feeding data for fleas feeding from blood sources such as, for example, a mammal or reptile. The flea feeding apparatus includes a containment system comprised of a subject-restraining apparatus and a removable housing that confines the fleas in proximity with the blood source in order to obtain in vivo flea feeding data. This invention allows a known quantity of fleas to feed on a test blood source undisturbed, followed by the recovery of all of the fleas for further observation and analysis, with minimal stress and manipulation of the blood source (test animal host).

### BRIEF DESCRIPTION OF THE DRAWINGS

FIG. 1 is a perspective view of an embodiment of the invention.

### DETAILED DESCRIPTION OF THE INVENTION

The present invention is an in vivo hematophagous feeding apparatus, for feeding hematophagous feeders on blood from a blood host, that comprises a blood host housing unit including a receiving port, the housing unit adapted to firmly constrain a blood host within the housing unit sufficient to maintain a spatial relationship of a desired feeding area of the blood host to the receiving port; and a hematophagous feeder containment unit including a feeding terminal wall; the flea containment unit adapted for insertion into the receiving port to maintain contact of the feeding terminal wall to the desired feeding area.

A method of the present invention for feeding hematophagous feeders directly onto a non-sedated blood host comprises the steps of placing the blood host into a restraining housing unit; the housing unit includes a receiving port; the housing unit is adapted to firmly constrain the blood host within the housing unit sufficient to maintain a spatial relationship of a desired feeding area of the blood host to the receiving port; placing a quantity of hematophagous feeders in a hematophagous feeder containment unit that includes a feeding terminal wall; the containment unit is adapted for insertion into the receiving port to maintain contact of the feeding terminal wall to the desired feeding area; and allowing the hematophagous feeders to feed through the feeding terminal wall by maintaining contact of the feeding terminal wall to the desired feeding area of the blood host for a determined period of time.

For convenience, hematophagous feeders will be generically identified as fleas in the descriptions that follow. One in the art readily understands the different requirements for other blood feeders.

The present invention of the in vivo flea feeder eliminates the need for a sedative, contains the fleas so they are not lost, and reduces flea manipulation to the one time that they are counted and sorted for the containment unit. The transparency of the glass apparatus and ease of handling of the flea containment unit allows flea feeding to be observed directly on mice as well as post-feeding behavior during incubation. The glass apparatus obviates the need for anesthetics and eliminates euthanizing the mice for flea recovery.

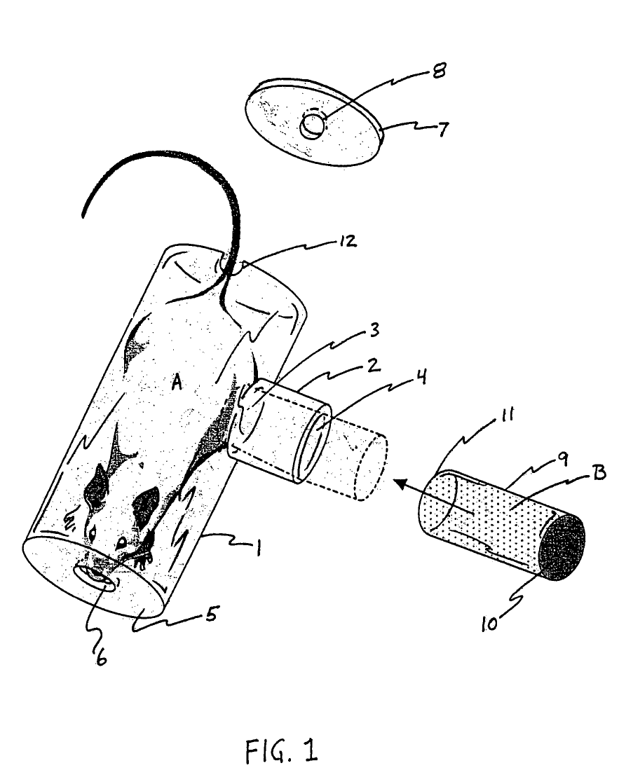

An embodiment of the invention is shown in FIG. 1. Referring to FIG. 1, a cylindrical tube 1 dimensioned to closely constrain a blood host A has a receiving port 2 situated on the longitudinal side of cylindrical tube 1. Receiving port 2 has an opening 3 through cylindrical tube 1 proximate to blood host A and an opening 4 distal to blood host A. Opening 3 is situated on the longitudinal side of cylindrical tube 1 such that blood host A, when constrained in cylindrical tube 1, presents the desired feeding area of blood host A in close proximity to opening 3. Cylindrical tube 1 includes a terminal wall 5 that includes one or more holes 6. Cylindrical tube 1 includes a second terminal wall 7 that includes one or more holes 8. Terminal wall 5 and second terminal wall 7 are one or both fastenably removable. One or more of hole 6 or 8 can be dimensioned to allow a tail of blood hose A to protrude out. Receiving port 2 is dimensioned to accept flea containment unit 9. Flea containment unit 9 includes a feeding terminal wall 11 and a closure wall 10. Flea containment unit 9 is dimensioned to allow fleas B to feed on blood host A through feeding terminal wall 11 when containment unit 9 is inserted through receiving port 2-to place feeding terminal wall 11 in contact with blood host A.

Still referring to FIG. 1, in one embodiment, cylindrical tube 1 includes a slot 12 to allow tail of blood host A to protrude from cylindrical tube 1.

Cylindrical tube 1 can be made from any convenient material such as, for example, metal, plastic, composite, glass, ceramic, paper, or mesh. Cylindrical tube 1 can be made of more than one section. It is preferred that cylindrical tube 1 be rigid sufficient to constrain blood host A to prevent movement of desired feeding area away from feeding terminal wall 11. It is preferred that cylindrical tube 1 be clear to allow monitoring of the position and condition of blood host A. Cylindrical tube 1 can have one or more breathing holes. It is less advantageous to use Plexiglas or rubber because of their static electricity properties. Further, wood, paper or other such porous materials are less advantageous because of cleaning and disinfecting problems —although they might be advantageous for single use disposable applications.

Receiving port 2 can be made from any convenient material such as, for example, metal, plastic, composite, glass, ceramic, paper, or mesh. It is less advantageous to use Plexiglas or rubber because of their static electricity properties. Further, wood, paper or other such porous materials are less advantageous because of cleaning and disinfecting problems—although they might be advantageous for single use disposable applications. Receiving port 2 can be made of more than one section. It is preferred that receiving port 2 be rigid sufficient to constrain flea containment unit 9 to prevent movement of feeding terminal wall 11 away from desired feeding area. It is preferred that receiving port 2 be clear to allow monitoring of the positions and conditions of fleas B, and the position of flea containment unit 9.

Terminal wall 5 can be made from any convenient material such as, for example, metal, plastic, composite, glass, ceramic, paper, or mesh. It is less advantageous to use Plexiglas or rubber because of their static electricity properties. Further, wood, paper or other such porous materials are less advantageous because of cleaning and disinfecting problems—although they might be advantageous for single use disposable applications. Terminal wall 5 can be made of more than one section. It is preferred that terminal wall 5 be rigid sufficient to constrain blood host A to prevent movement of desired feeding area away from feeding terminal wall 11. It is preferred that terminal wall 5 be clear to allow monitoring of the position and condition of blood host A. Terminal wall 5 can have one or more breathing holes.

Terminal wall 5 can be integral to cylindrical tube 1 or be fastenably removable. If removable, terminal wall 5 can be fastened to cylindrical tube 1 by any convenient way such as, for example, by mating screw threads, by hook and eye fastening, by elastic banding, by firm “O”-ring press fit, by fastening screws, or by string and knots.

Terminal wall 7 can be made from any convenient material such as, for example, metal, plastic, composite, glass, ceramic, paper, or mesh. It is less advantageous to use Plexiglas or rubber because of their static electricity properties. Further, wood, paper or other such porous materials are less advantageous because of cleaning and disinfecting problems—although they might be advantageous for single use disposable applications. Terminal wall 7 can be made of more than one section. It is preferred that terminal wall 7 be rigid sufficient to constrain blood host A to prevent movement of desired feeding area away from feeding terminal wall 11. It is preferred that terminal wall 7 be clear to allow monitoring of the position and condition of blood host A. Terminal wall 7 can have one or more breathing holes.

Terminal wall 7 can be integral to cylindrical tube 1 or be fastenably removable. If removable, terminal wall 7 can be fastened to cylindrical tube 1 by any convenient way such as, for example, by mating screw threads, by hook and eye fastening, by elastic banding, by firm “O”-ring press fit, by fastening screws, by string and knots, or by temporary frangible gluing.

If terminal wall 5 and terminal wall 7 are both integral to cylindrical tube 1, then cylindrical tube 1 should have a door to allow placement of blood host A into cylindrical tube 1.

In a preferred embodiment, the feeding terminal wall 11 is penetrable by the mouth parts of fleas and allows for gas exchange. This allows the fleas to feed undisturbed.

Flea containment unit 9 can be made from any convenient material such as, for example, metal, plastic, composite, glass, ceramic, paper, or mesh. It is less advantageous to use Plexiglas or rubber because of their static electricity properties. Further, wood, paper or other such porous materials are less advantageous because of cleaning and disinfecting problems—although they might be advantageous for single use disposable applications. Flea containment unit 9 can be made of more than one section. It is preferred that flea containment unit 9 be rigid sufficient to prevent movement of feeding terminal wall 11 from desired feeding area. It is preferred that flea containment unit 9 be clear to allow monitoring of the position and condition of fleas B.

Flea containment unit 9 can be any convenient cross-sectional shape such as, for example, circular, rectangular, oval, or stellar. It is more convenient for the cross-section of the flea containment unit 9 to correspond to the cross-section of the receiving port 2. Nevertheless, the cross-sections can be different while still allowing the insertion and removal of flea containment unit 9 from cylindrical tube 1, as would be apparent to one in the art, to facilitate blood-feeding experiments.

Flea containment unit 9 can be maintained in a spatial relationship to receiving port 2, after insertion to place feeding terminal wall 11 in contact with the desired feeding area of the blood host, by any convenient method such as, for example, friction (“O”-ring, gasket, grease, elastic band, taper fitting, sintered glass surfaces), mating threads, hook and eye, elastic banding, twine, screws, pins, or frangible gluing.

Receiving Port 2 can be at any convenient angle relative to cylindrical tube 1 that allows feeding terminal wall 11 to be in contact with the desired feeding area of the blood host when flea containment unit 9 is inserted. It is advantageous that the angle be about perpendicular to longitudinal axis of cylindrical tube 1 although other angles can be utilized with concurrent adaptation of dimensions and angles of flea containment unit 9 as would be apparent to one in the art.

In one embodiment, cylindrical tube 1 includes an air portal on one of the terminal walls where the nose of the host animal is placed to allow it to breathe freely and another terminal wall that includes an aperture for the tail to be inserted and secured.

Animals suitable for use in the system of the present invention include small animal hosts such as the mouse or rat. Using the apparatus of this invention, it is possible to identify agents such as drugs, systemic pesticides capable of inhibiting flea infestation. Thus, the present invention further relates to the use of the apparatus in assays to identify agents capable of inhibiting flea infestation. The present invention relates to a method for maintaining fleas in a closed system, which mimics the natural conditions of fleas that feed freely on an animal.

The in vivo flea feeder of this invention can be conveniently used for a single time point efficacy study, time-course studies and repellence studies. The proportion of the cylindrical tube can be conveniently adapted to various sizes and shapes of blood hosts. Rats would require larger dimensions from mice, as would be apparent to one in the art. The longitudinal tube should be sized to constrain firmly the blood host so that the flea containment unit maintains firm contact with the desired feeding area of the blood host.

Different mesh sizes can be conveniently used for the feeding terminal wall 11 to allow fleas, different insects, as well as other arthropods to be tested and utilized. In use, the blood host such as a mouse is constrained in the cylindrical tube and the flea containment unit is attached to the cylindrical tube such that the fleas are able to feed on the mouse through the feeding terminal wall.

In one particular embodiment, the flea containment unit of the apparatus is a 11×2 cm glass tube covered with mesh on one end and held in place with an O-ring. After introducing the fleas into the glass tube, parafilm is used to form the closure wall to prevent flea escape. A separate glass container was designed to restrain mice for feeding fleas.

One object of the invention is to provide a small animal flea assay, which would spare testing of insecticides in larger animals. The glass apparatus was developed to allow fleas to feed undisturbed on laboratory mice. This apparatus mouse/flea model using the glass apparatus serves as a viable small mammal assay that could further characterize and screen drug candidates prior to testing in dogs or to aid the characterization of novel compounds prior to testing on target species.

The diameter of wall is selected to abut the portion in such a manner as to produce a sliding fit with sufficient resistance to require torque applied by both hands for undoing. The O-ring 15 and bushing 16 provide the means to secure the flea cage 2 once inserted in the extension 20 perpendicular to the longitudinal extent of tube 1. The flea cage feeder 2 mimics natural feeding conditions and allows undisturbed feeding.

The present invention also provides a method for restraining an animal to be tested, comprising the steps of:

(a) exposing the side or abdomen of the animal;

(b) advancing animal (headfirst is easier) into a tube having an open end to accept the animal and a generally circular opening within the interior wall of the tube, the slot sized and shaped to allow exposure by the flea cage; and

(c) implementing testing or examination of the animal.

### EXAMPLE

### In vivo Flea Feeding Apparatus (IFFA)

A mouse was placed headfirst into a ventilated, cylindrical 8×2.5 cm tube restraining apparatus so that its nose protruded from the opening at one end of the tube. The glass tube containing fleas was then inserted perpendicularly into an opening in the restraining apparatus so that the mesh end of the flea containing glass tube was in contact with the abdomen of the mouse. The mesh side of the glass tube containing the fleas was pressed against the mouse to allow the fleas to feed undisturbed for a predetermined length of time. The tube containing the fleas was then removed and placed directly into an incubator (28° C.: 85RH; 12:12) and the mouse released.

The flea containment tube was an 11×2 cm glass tube covered with nylon 500 micrometer mesh at one end. After 30 adult fleas were placed in the tube, the open end was sealed with Parafilm, inserted into an opening in the cylindrical tube containing the mouse, and the fleas were allowed to feed. The tube was held by an “O”-ring in place perpendicular to the mouse restraining tube apparatus

What is claimed is:

1. An in vivo hematophagous feeding apparatus, for feeding hematophagous feeders on blood from a blood host, comprising:
a blood host housing unit including a receiving port; said housing unit adapted to firmly constrain a blood host within said housing unit sufficient to maintain a spatial relationship of a desired feeding area of said blood host to said receiving port; and
a hematophagous feeder containment unit including a feeding terminal wall; said containment unit adapted for insertion into said receiving port to maintain contact of said feeding terminal wall to said desired feeding area.

2. The in vivo hematophagous feeding apparatus of claim 1, wherein said housing unit is a cylindrical transparent tube.

3. The in vivo hematophagous feeding apparatus of claim 1, wherein the feeding terminal wall is a mesh sheet.

4. The in vivo hematophagous feeding apparatus of claim 1, wherein the containment unit is adapted for insertion by an “O”-ring and bushing to frictionally maintain a spatial relationship of the containment unit to the housing unit sufficient to maintain contact of the feeding terminal wall to the desired feeding area.

5. The in vivo hematophagous feeding apparatus of claim 3, wherein the mesh sheet is a metallic mesh, spun thread mesh, or woven cloth mesh.

6. The in vivo hematophagous feeding apparatus of claim 3, wherein the mesh has pore openings of about 500 micrometer.

7. A method for feeding hematophagous feeders directly onto a non-sedated blood host comprising the steps of
placing the blood host into a restraining housing unit; the housing unit including a receiving port; said housing unit adapted to firmly constrain the blood host within said housing unit sufficient to maintain a spatial relationship of a desired feeding area of said blood host to said receiving port;
placing a quantity of hematophagous feeders in a hematophagous feeder containment unit including a feeding terminal wall; said containment unit adapted for insertion into said receiving port to maintain contact of said feeding terminal wall to said desired feeding area; and
allowing the hematophagous feeders to feed through the feeding terminal wall by maintaining contact of said feeding terminal wall to said desired feeding area of the blood host for a determined period of time.
